(19) United States
(12) Patent Application Publication
(10) Pub. No.: US 2018/0072862 A1
(43) Pub. Date: Mar. 15, 2018

(54) THERMOPLASTIC ELASTOMERS DERIVED FROM DE-VULCANIZED RUBBER

(71) Applicant: NEW RUBBER TECHNOLOGIES HOLDINGS, INC., San Rafael, CA (US)

(72) Inventor: James F. FISHER, Singhampton (CA)

(21) Appl. No.: 15/705,112

(22) Filed: Sep. 14, 2017

Related U.S. Application Data
(60) Provisional application No. 62/394,500, filed on Sep. 14, 2016.

(51) Int. Cl. C08J 11/18; C08J 3/00; C08J 3/205; C08L 23/16; C08L 9/06; C08L 9/02

(52) U.S. Cl. CPC C08J 11/18; C08J 3/005; C08J 3/205; C08L 2207/04; C08L 9/06; C08L 9/02; C08J 2319/00; C08L 23/16

(57) ABSTRACT

A thermoplastic copolymer is made by first de-vulcanizing a sulfur-crosslinked elastomeric material to produce a liquid phase component. The liquid phase component is subsequently mixed with a compatible thermoplastic polymer at a temperature above its melting point thereof, and the resulting mixture is cooled to produce a solid product.

### CROSS-REFERENCE TO RELATED APPLICATION

This application claims the benefit of U.S. Provisional Application No. 62/394,500 filed Sep. 14, 2016, incorporated by reference herein.

### FIELD

This invention relates to the field of polymer chemistry, and in particular to a method of making thermoplastic elastomers (TPEs).

### BACKGROUND

A thermoplastic polymer (a plastic) becomes pliable or moldable above a specific temperature and returns to a solid state upon cooling. Thermoplastics generally have a crystalline structure and differ from thermosetting polymers that have an amorphous structure which provides for the properties of elasticity. Thermoset polymers (or thermosets) do not melt, but rather soften above a specific temperature, but then do not reform upon cooling. In its original virgin (or uncured) state, thermosets are super viscous liquids which require the introduction of a curing agent like sulfur or peroxide to form cross-linking chemical bonds during the curing (or vulcanization) process. These cross-links cannot be reversed simply by the application of temperature.

An elastomer (rubber) is a thermoset polymer with viscoelasticity, and as such, is capable of viscosity reduction under applied strain or shear but only if in an uncured (super viscous) state. To become a solid, thermosets require vulcanization to create cross-linking chemical bonds which provide for this solid structure and will no longer be subject to viscosity reduction by the application of shear. De-vulcanization, in turn, largely reverses the thermoset elastomer state from solid back to super viscous liquid by breaking these cross-links.

Thermoplastic elastomers (TPEs) are a class of copolymers or terpolymers, or a physical mix of polymers (including a plastic and a rubber), which consist of materials with both thermoplastic and elastomeric properties. While most elastomers are thermosets, thermoplastics as thermoforms are in contrast relatively easy to use in manufacturing, for example, by injection molding. TPEs exhibit the advantage of combining the physical properties of both elastomeric materials and plastic materials as well as the processing (manufacturing) advantages of thermoplastic materials. The principal difference between thermoset elastomers and TPEs is the presence of crosslinking bonds in the structure of cured elastomers. In fact, crosslinking is a critical structural factor that contributes to impart high elastic properties. While a class of vulcanized (cured) TPEs does exist, TPEs are thermoplastics which typically do not require cross-linking.

Currently, virgin TPEs are created by the polymerization of random co-block polymers of monomers common to both elastomers and thermoplastics through the solution polymerization of hydrocarbon derived monomers. Elastomers are polymers where the monomer distribution in the polymer chain is completely random. Thermoplastics have crystalline ordered structures which contribute to their ability to melt and re-solidify. In the case of TPEs, the attributes of both elastomers and thermoplastics are achieved by polymerizing the molecules in alternating blocks of random elastomer segments and crystalline (ordered) thermoplastic segments. This creates a hybrid molecule that displays melting behavior with elastomeric physical properties.

Examples would be Kraton™ SBS co-block polymer, or Engage™ Ethylene polybutene co-block polymer. In the case of Kraton™, the SBS block copolymers are composed of blocks of styrene and butadiene. SBS is prevalent in footwear and the modification of bitumen/asphalt. It is also very useful in pressure sensitive adhesives, hot melt spray diaper adhesives, construction adhesives, impact modification of styrenics, thermoformed clear rigid packaging, and as one of a number of ingredients in compounds to be used in either injection molding, extrusion or thermoforming processes.

U.S. Pat. No. 6,313,183 (Pillai & Chandra) discloses a method of making thermoplastic elastomers from vulcanized rubber scrap material and olefinic plastic wherein the vulcanized scrap material is blended with the olefinic plastic in the presence of de-vulcanizing additives. This patent stipulates and is predicated upon using common rubber curing accelerators (DPG and dibenzothiazole disulphide) as de-vulcanization agents. DPG and dibenzothiazole disulphide, as common rubber curing accelerators, and dibenzothiazole disulphide as a disulphide specifically, will reform cross links within the “de-vulcanized” elastomer at the process temperatures specified in the patent. The temperatures specified within the patent are required both to melt the crystalline plastic as well as soften the elastomer sufficiently to enable processing in the specified mixing apparatus. The resulting inadequacies of this “mix” of a largely vulcanized solid elastomer with a molten plastic liquid significantly reduce the subsequent melt flow of the material. This is in turn a detriment to utilizing these materials in subsequent injection molding and/or other thermoplastic manufacturing processes. Furthermore, the pre-treatment of the material described in U.S. Pat. No. 6,313,183 has the effect of sheeting the cured rubber scrap and making an additional process step in the form of grinding necessary to introduce the material into a thermoplastic compounding process, inclusive of the apparatus described in that patent.

U.S. Pat. No. 6,813,109 (Lev-Gum) describes a method of de-vulcanizing cross-linked elastomers with the assistance of chemical additives.

U.S. Pat. No. 8,673,989 B2 (New Rubber Technologies) describes a method of de-vulcanizing cross-linked elastomers with the assistance of chemical additives.

WO 2014/124441 discloses elastomers from reclaimed material wherein the starting materials include devulcanized particulate.

### SUMMARY

In general terms, embodiments of the invention relate to polymer materials that are blends of thermoplastics and elastomers, in which the elastomers are derived from a vulcanized/cured source. Typically the elastomer originates from a waste stream, but in any case is comprised of a vulcanized elastomer. The thermoplastic may be comprised of monomers, copolymers or terpolymers. In the case of the plastic blends or polyblends, the material is generally designed to retain the best characteristics of each component material. The thermoplastic elastomer blend is also designed to retain the best characteristics of the thermoplastic(s) and the elastomer(s).

Embodiments of the invention address the problem inherent in the prior art which produces material that exhibits characteristics of thermoplastic elastomers derived from vulcanized elastomer waste and thermoplastics, in which there is insufficient melt flow to utilize the material in standard thermoplastic processing equipment such as extrusion and injection molding, and which also yields materials with other physical property inadequacies.

According to an embodiment of the present invention, there is provided a method of making a thermoplastic elastomer, comprising: utilizing a de-vulcanized elastomeric material to produce a liquid phase component; mixing said liquid phase component with a compatible thermoplastic polymer at a temperature above the melting point thereof; and cooling the resulting mixture to produce a solid product. Ideally, this temperature is less than 5 deg Celsius above the melt point.

It is contemplated in embodiments of the invention that the elastomeric phase be de-vulcanized sufficiently prior to mixing with the thermoplastic to produce a liquid phase component. Vulcanization is a chemical process for converting virgin rubber or related elastomer polymers into more durable materials via the addition of sulfur, peroxide or other equivalent curatives or accelerators. These additives modify the polymer by forming cross-links between individual polymer chains.

De-vulcanization reverses this process by breaking the crosslinks between the polymer molecules to create a precursor material that can be used in the manufacture of a number of products.

The sequential staging of the de-vulcanization and blending/mixing in accordance with embodiments of the present invention allows the elastomer to change phase from a solid to a highly viscous liquid. In the liquid phase, under shear mixing, the de-vulcanized elastomer can co-mingle with the melted liquid phase thermoplastic to produce a more homogeneous blend resulting in improved physical properties including greater impact resistance, lower brittleness temperatures, increased elongation at breakage, and lower flexural modulus.

In particular, the amorphous elastomer phase of the blend prevents the growth of micro-fissures upon impact, and as such imparts higher impact strength on the crystalline thermoplastic phase of the alloy, which in turn results in a lower flexural modulus. In a thoroughly mixed liquid-to-liquid phase blending process, this effect is maximized. By contrast, the mixing of a pulverized solid (i.e. cured or vulcanized) rubber particulate does not create intimate enough blending to realize this effect.

Maximizing the physical properties of polymer blends is dependent on the degree of comingling of the polymers on a molecular level. Elastomers typically require much higher shear when mixing than do thermoplastics to achieve high levels of dispersion. The differential in viscosities between the elastomer and plastic phases makes thorough blending of the materials difficult in conventional thermoplastic or rubber mixers unless said equipment provides the ability to vary shear and temperature inputs, and the sequencing thereof. As an example, utilizing a twin screw extruder with interchangeable screw elements allows for a varied range of shear and mixing temperatures to maximize comingling of the blend elements. However, one skilled in the art will appreciate that any high shear mixer with variable process condition control can be used.

In order to have the elastomeric phase and thermoplastic phase homogenize as per embodiments of the present invention, three basic principles should be applied;
Introduction of the elastomer phase to the mixer in advance of the thermoplastic phase of the blend
Reduction of the elastomer phase viscosity by applied shear using the mixer
Introduction of the thermoplastic phase at a process temperature minimally above the melt point of the utilized plastic. This can be accomplished by determination of the melt point and maintaining the process maximum temperature ideally within 5 deg Celsius above the melt point of the material.

De-vulcanized rubber particulate (DRP) in accordance with the teachings of this invention will contribute to the viscosity reduction of the elastomer phase which has achieved a super-viscous liquid state by de-vulcanization prior to the mixing process. One such example is the material derived from the method disclosed in U.S. Pat. No. 8,673,989 B2, but one skilled in the art will readily recognize that any number of de-vulcanized rubber particulates (DRP) can be used within the scope of embodiments of this invention. Once liquefied, the elastomer is capable of viscosity reduction by induced shear of the mixer. Introducing the thermoplastic at a process temperature minimally above its melt point will add the plastic at its maximum possible viscosity. The narrower the gap in viscosity between polymer phases, the more homogeneous the mixture will result. A maximally homogeneous mixture will yield the highest possible physical properties.

Expected physical property improvements of embodiments of the invention as illustrated in Table 3 below include, higher tensile strength at break, higher ultimate elongation, higher impact resistance (IZOD), improved melt flow and lower flexural modulus. In blends that are predominantly elastomeric (>50%), these blends exhibit, by way of example, elastomeric qualities of lower hardness (durometer) and a higher coefficient of friction (grip) than is characteristic of thermoplastics.

### BRIEF DESCRIPTION OF FIGURES

Embodiments of the invention will now be described in conjunction with the accompanying drawings, wherein:

FIG. 1: Illustrates an example using Primary Screw Configuration for Leistritz 27.5 mm Twin Screw Extruder

FIG. 2: Illustrates an example using Secondary Screw Configuration for Leistritz 27.5 mm Twin Screw Extruder

FIG. 3: Illustrates an example using Tertiary Screw Configuration of 27.5 mm Leistritz Twin Screw Extruder

This invention will now be described in detail with respect to certain specific representative embodiments thereof, the materials, apparatus and process steps being understood as examples that are intended to be illustrative only. In particular, the invention is not intended to be limited to the methods, materials, conditions, process parameters, apparatus and the like specifically recited herein.

### DETAILED DESCRIPTION

Embodiments of the invention are based on the discovery that maximizing the physical properties of polymer blends is dependent upon the degree of comingling of the polymers on a molecular level. Elastomers typically require much higher shear when mixing than do thermoplastics to achieve high levels of dispersion. The differential in viscosities between the elastomer and plastic phases makes thorough blending of the materials difficult in some conventional thermoplastic or rubber mixers.

The present applicant has discovered that in order to have the elastomeric phase and thermoplastic phase homogenize, it is ideal if the mixing temperature is minimally above the glass transition temperature of the thermoplastic phase. Further escalation above this minimal temperature increment above the glass transition temperature may result in over softening of the thermoplastic phase to the extent that it will not present sufficient resistance to shear (because of insufficient viscosity) in order to fully disperse into the elastomeric phase within it. However, precise temperature control during mixing may present a technical challenge to the required dispersion of the elastomeric phase.

The applicant has further discovered that techniques to enhance dispersion of the elastomeric phase into the composite could involve delayed introduction of the thermoplastic constituent through a side feeder after initial viscosity-reduction of the elastomeric phase. The temperature profile along the barrel length should be gradually increased to the glass transition temperature of thermoplastic phase at the point of the side feeder barrel section. By narrowing the viscosity gap between the phases before mixing a more thorough homogenous mix will be achieved.

In general, a significant distinction over the prior art is that the elastomeric material is sufficiently de-vulcanized into the liquid state before blending with the plastic resin such that it is susceptible to the further shear-induced viscosity-reduction of the mixing apparatus prior to the introduction of the thermoplastic into the mixing process. In the liquid state, the material is alternatively re-vulcanizable (using curing agents) as a stand-alone rubber compound, with or without the addition of plastic resin.

The de-vulcanization of the subject elastomeric material prior to its blending in accordance with embodiments of the present invention prevents re-crosslinking unless extra sulphur is added. The pre de-vulcanized liquid phase of the elastomer allows for shear induced viscosity reduction, enhancing the resultant physical properties of the blend. As an example, it solves the problem of impact resistance and brittleness of thermoplastics given the intimate mixing between the de-vulcanized elastomer(s) and thermoplastic components deriving a material with thermoplastic elastomer properties.

Embodiments of the first step of the present invention utilizes free flowing powder (that is a super viscous liquid) that is optimally applicable to extrusion compounding equipment and processes. Free flowing powder material is easily introduced via continuous loss-in-weight feeders at the extrusion compounding stage as typical thermoplastic or TPE compounding equipment anticipates granulated or pelletized materials.

Methods in accordance with embodiments of the invention can be used with any thermoplastic resin as long as the elastomer component is compatible (common monomers) with the aforementioned thermoplastic resin. The liquid phase mixing is ideally carried out (<5 Celsius) above the melt temperature of the thermoplastic. Ideally, the elastomer is subjected to a targeted level of mechanical shear to reduce its viscosity to the targeted level and as achievable by the geometry of the screws or applied energy of the mixing apparatus.

The physical properties of these mixtures made in accordance with embodiments of the invention are dependent on the specific elastomer and thermoplastic polymers used, the thermoplastic/elastomer ratio and the process conditions utilized during the mixing process. Process conditions should be optimized for the particular materials used. Process conditions include mixing temperature, mixer elements (including rotors or screws), and applied power.

Preferably, the blending process takes place in a high shear mixer typical in the elastomer, plastic or TPE compounding industries including but not limited to twin screw extruders, Farrell Continuous Mixers (FCMs) or Banbury mixers for example, wherein the apparatus is maintained above the melt temperature of the plastic resin and induces a level of desired shear applicable to the elastomer.

The starting material can be any de-vulcanized rubber particulate derived from any cross-linked elastomer compound that has been reduced to the liquid phase by virtue of its pre-de-vulcanization. Some specific examples of such suitable materials are shown in the non-limiting table below.

The post-consumer, post-industrial or virgin thermoplastic(s) should be in the form of suitable monomers, copolymers or terpolymers that are miscible with corresponding liquid-phase de-vulcanized rubber material, which is referred to herein as de-vulcanized rubber particulate or by the acronym DRP.

Non-limiting examples of suitable copolymers and DRP combinations include:
Polyolefin-EPDM DRP
ABS-NBR DRP
PVC-Polychloroprene DRP
Polystyrene-Styrene-Butadiene DRP
Polyolefin-Isobutylene DRP
   where EDPM stands for ethylene propylene diene monomer, ABS stands for acrylonitrile butadiene styrene, NBR stands for acrylonitrile-butadiene rubber and PVC stands for polyvinyl chloride.

The thermoplastic (crystalline phase) material provides rigidity, melt-formability and melt flow. The elastomeric (amorphous phase) material provides ductile strength, flexibility, impact resistance, and resistance to cold temperature brittleness.

If desired, it may be advantageous to add more than one thermoplastic or elastomer to provide specific material properties such as solvent resistance, high temperature resistance or any benefit that is provided by each and any of the virgin elastomers and thermoplastics singularly or as copolymers.

Non-limiting specific examples that have been tested by the current Applicant include:
Varying proportions of EPDM DRP with either virgin or “regrind” (i.e. either post-consumer or post-industrial) HDPE
Varying proportions of EPDM DRP with either virgin or regrind LLDPE
Varying proportions of EPDM DRP with virgin polypropylene homo-polymer
Varying proportion of NBR DRP and ABS/PC regrind
Varying proportions of SBR/NR (post-consumer tire crumb) DRP with HDPE
Varying proportions of SBR/NR (post-consumer tire crumb) DRP with LLDPE
   where HDPE is high-density polyethylene, NBR is acrylonitrile-butadiene rubber, LLDPE is low linear density polyethylene and ABS (from post-consumer e-waste computer cases)/PC is acrylonitrile butadiene styrene blended with polycarbonate resin.

After mixing, the resulting mixture is cooled to produce a solid product.

The physical properties of the blends of various experiments are shown in the following tables. In each case, the elastomer was first fully de-vulcanized into the liquid phase and subsequently blended using a twin screw extruder or Banbury mixer as indicated. Table 1 is a summary of examples wherein only recycled thermoplastics were blended with recycled rubber EPDM DRP and SBR/NR DRP (made from mixed passenger and truck Tire crumb). Table 2 is a summary of examples wherein only virgin thermoplastic resins were blended with EPDM DRP. The EPDM DRP was blended at increasing levels to virgin polyolefin resins (LDPE, HDPE and PP) and the virgin properties of the resin are used as a control group.

TABLE 1
Blends utilizing post-consumer or post-industrial thermoplastics

| | | Recycled | | | | | | | | |
|---|---|---|---|---|---|---|---|---|---|---|
| | | Composites | | | | | | | | |
| Plastic | Elastomer | Plastic | | Physical Property Measurements | | | | | Mixer | |
| Resin | (Rubber) | Resin | Rubber | Tensile | Elonga- | Duro- | | Melt | or | |
| Description | Descritpion | (%) | (%) | (MPa) | tion (%) | meter | IZOD | Flow | Blender | Molding |
| Post- | 60 | 30 | 70 | 8.4 | 2 | 98 | 4.3 | 8.4 | Twin | Injection |
| Consumer | Durometer | | | | | | | | Screw | |
| HDPE | EPDM | | | | | | | | | |
| Post- | 60 | 50 | 50 | 6.2 | 25 | 82 | 6.5 | 4.4 | Twin | Injection |
| Consumer | Durometer | | | | | | | | Screw | |
| HDPE | EPDM | | | | | | | | | |
| Post- | 60 | 70 | 30 | 5.9 | 300 | 75 | Un- | 0.6 | Twin | Injection |
| Consumer | Durometer | | | | | | break- | | Screw | |
| HDPE | EPDM | | | | | | able | | | |
| LLDPE Film | Passenger | 50 | 50 | 4.7 | 10 | 75 | | | Banbury | Compres- |
| Scrap | Tire Crumb | | | | | | | | | sion |
| LLDPE Film | Passenger | 30 | 70 | 4.00 | 125 | 72 | Un- | 0.2 | Banbury | Compres- |
| Scrap | Tire Crumb | | | | | | break- | | | sion |
| | | | | | | | able | | | |
| Post- | 70 | 30 | 70 | 12.1 | 533 | 85 | Un- | 0.4 | Banbury | Compres- |
| consumer | Durometer | | | | | | break- | | | sion |
| HDPE | EPDM | | | | | | able | | | |

TABLE 2
Blends utilizing virgin thermoplastics

| | | | | | | Melt |
|---|---|---|---|---|---|---|
| | | | | | | Flow |
| | | | Tensile | Tensile | Notched | MFI |
| | Formu- | Resin | Strength | Modulus | Izod | (gm/10 |
| | lation | (%) | (MPa) | (MPa) | (J/m) | min) |
| Control | Dowlex | 100 | 9 | 237 | 399 | 25 |
| Resin | 2517 | | | | | |
| 1 | 83070 | 70 | 9 ± 0.7 | 162 ± 16 | 289 | 7.8 |
| | LLDPE | | | | | |
| | VIR60 | | | | | |
| 2 | 85050 | 50 | 10 ± 0.9 | 90 ± 3 | 338 | 4.2 |
| | LLDPE | | | | | |
| | VIR60 | | | | | |
| 3 | 87030 | 30 | 7 ± 0.6 | 66 ± 11 | 242 | FRAC |
| | LLDPE | | | | | |
| | VIR60 | | | | | |
| Control | Dow | 100 | 25 | 870 | 55 | 25 |
| Resin | 25455E | | | | | |
| 4 | 83070 | 70 | 18 ± 0.6 | 428 ± 17 | 81 | 6.48 |
| | HDPE | | | | | |
| | VIR60 | | | | | |
| 5 | 85050 | 50 | 12 ± 0.4 | 266 ± 18 | 285 | 5.76 |
| | HDPE | | | | | |
| | VIR60 | | | | | |
| 6 | 87030 | 30 | 11 ± 0.7 | 169 ± 15 | 391 | FRAC |
| | HDPE | | | | | |
| | VIR60 | | | | | |
| Control | Ineos | 100 | 26 | 1340 | No | 25 |
| Resin | N02G-00 | | | | Break | |
| 7 | 83070 PP | 70 | 15 ± 0.9 | 393 ± 12 | 396 | 10.68 |
| | VIR60 | | | | | |
| 8 | 85050 PP | 50 | 11 ± 0.3 | 221 ± 18 | 454 | 5.16 |
| | VIR60 | | | | | |
| 9 | 87030 PP | 30 | 8.0 +/_ 0.3 | 133 +− 18 | 366 | Frac |
| | VIR60 | | | | | |

where 83070 means 30% EPDM and 70% of the subsequently listed thermoplastic; where 85050 means 50% EPDM and 50% of the subsequently listed thermoplastic; and where 87030 means 70% EPDM and 30% of the subsequently listed thermoplastic.

Tensile strength indicates pressure required to break sample under an applied tensile strain, tensile modulus indicates rigidity of the sample, impact resistance indicates energy required to fracture the sample when struck and melt flow indicates the materials ability to flow when heated (also an indication of material processibilty in product manufacturing).

TABLE 3
Blends utilizing different processing conditions

| | Part 1: Screw Configuration and Extrusion Temperature Effects | | | | | | | | | | | | | | |
|---|---|---|---|---|---|---|---|---|---|---|---|---|---|---|---|
| Low Intensity Screw | 17030 HIPS | | | 47030A BS | | | 87030LLDPE | | | 87030HDPE | | | 87030PP | | |
| Test | 150.00 | 160.00 | 170.00 | 175.00 | 200.00 | 225.00 | 170.00 | 185.00 | 200.00 | 170.00 | 185.00 | 200.00 | 170.00 | 185.00 | 200.00 |
| TEMP | | | | | | | | | | | | | | | |
| Tensile Mpa | 4.95 | 5.18 | 5.12 | 5.72 | 6.01 | 6.58 | 5.54 | 5.36 | 5.39 | 6.88 | 7.21 | 7.32 | 12.16 | 12.12 | 11.71 |
| Elongn | 35.00 | 8.00 | 1.00 | 14.58 | 19.17 | 21.20 | 218.00 | 214.00 | 207.00 | 50.70 | 102.60 | 84.90 | 50.00 | 40.00 | 50.00 |
| Duro | 85.00 | 85.00 | 85.00 | 90.00 | 90.00 | 90.00 | 80.00 | 80.00 | 80.00 | 85.00 | 85.00 | 85.00 | 90.00 | 90.00 | 90.00 |
| IZOD ft-lb/in | 4.42 | 3.71 | 3.43 | 2.64 | 2.08 | 2.37 | 3.88 | 3.38 | 3.51 | 3.60 | 3.86 | 3.87 | 2.84 | 2.97 | 2.80 |
| MFI g/10 min | 0.40 | 0.42 | 0.47 | 2.56 | 1.25 | 0.79 | 13.28 | 18.68 | 22.12 | 11.35 | 9.02 | 3.49 | 30.72 | 25.99 | 22.88 |
| 230 C. 5 kg wt | | | | | | | | | | | | | | | |
| FlexMODMpa | | 401.00 | 426.00 | 452.00 | 464.00 | 421.00 | 96.00 | 85.30 | 72.70 | 668.00 | 634.00 | 1903.00 | 407.00 | 497.00 | 423.00 |
| Medium Intensity Screw | 17030 HIPS | | | 47030A BS | | | 87030LLDPE | | | 87030HDPE | | | 87030PP | | |
| Test | 150.00 | 160.00 | 170.00 | 175.00 | 200.00 | 225.00 | 170.00 | 185.00 | 200.00 | 170.00 | 185.00 | 200.00 | 170.00 | 185.00 | 200.00 |
| Tensile Mpa | 5.07 | 5.06 | 5.08 | 6.20 | 6.00 | 6.10 | 5.02 | 2.65 | 5.17 | 6.74 | 6.91 | 6.39 | 7.16 | 8.54 | 8.29 |
| Elongn | 53.00 | 71.00 | 73.00 | 22.00 | 212.00 | 20.00 | 190.00 | 214.00 | 175.00 | 57.00 | 57.00 | 61.00 | 49.70 | 76.90 | 70.20 |
| Duro | 85.00 | 85.00 | 85.00 | 90.00 | 90.00 | 90.00 | 80.00 | 80.00 | 80.00 | 85.00 | 85.00 | 85.00 | 90.00 | 90.00 | 90.00 |
| IZOD ft-lb/in | 4.32 | 5.14 | 4.30 | 3.03 | 2.79 | 2.59 | 4.78 | 4.32 | 4.30 | 4.45 | 4.38 | 4.64 | 3.00 | 8.95 | 3.74 |
| MFI g/10 min | 0.21 | 0.15 | 0.12 | 1.25 | 0.51 | 0.46 | 11.00 | 17.85 | 23.00 | 6.52 | 7.55 | 10.51 | 16.10 | 16.10 | 15.90 |
| 230 C. 5 kg wt | | | | | | | | | | | | | | | |
| FlexMODMpa | 287.00 | 256.00 | 284.00 | 558.00 | 562.00 | 546.00 | 62.00 | 61.00 | 78.00 | 168.00 | 159.00 | 142.00 | 235.00 | 256.00 | 284.00 |
| High Intensity Screw | 17030 HIPS | | | 47030A BS | | | 87030LLDPE | | | 87030HDPE | | | 87030PP | | |
| Test | 150.00 | 160.00 | 170.00 | 175.00 | 200.00 | 225.00 | 170.00 | 185.00 | 200.00 | 170.00 | 185.00 | 200.00 | 170.00 | 185.00 | 200.00 |
| Tensile Mpa | 5.25 | 4.88 | 5.24 | 6.04 | 6.21 | 6.17 | 5.57 | 5.24 | 5.45 | 7.21 | 7.19 | 7.69 | 8.89 | 8.94 | 9.04 |
| Elongn | 68.00 | 72.00 | 64.00 | 23.00 | 22.00 | 22.00 | 235.00 | 200.00 | 187.00 | 52.00 | 45.00 | 47.00 | 54.00 | 58.00 | 57.00 |
| Duro | 85.00 | 85.00 | 85.00 | 90.00 | 90.00 | 90.00 | 80.00 | 80.00 | 80.00 | 85.00 | 85.00 | 85.00 | 90.00 | 90.00 | 90.00 |
| IZOD ft-lb/in | 4.41 | 4.80 | 4.60 | 3.16 | 2.71 | 1.94 | 4.03 | 4.02 | 4.07 | 4.62 | 4.13 | 3.91 | 3.44 | 4.16 | 3.35 |
| MFI g/10 min | 0.19 | 0.10 | 0.17 | 0.38 | 0.34 | 0.48 | 16.32 | 17.10 | 19.84 | 9.88 | 4.19 | 3.14 | 24.10 | 24.70 | 25.60 |
| 230 C. 5 kg wt | | | | | | | | | | | | | | | |
| FlexMODMpa | 345.00 | 287.00 | 340.00 | 438.00 | 497.00 | 537.00 | 57.00 | 58.00 | 66.00 | 218.00 | 262.00 | 245.00 | 301.00 | 292.00 | 329.00 |
| Ave Temp Effects | 150.00 | 160.00 | 170.00 | 175.00 | 200.00 | 225.00 | 170.00 | 185.00 | 200.00 | 170.00 | 185.00 | 200.00 | 170.00 | 185.00 | 200.00 |
| Tensile Mpa | 5.09 | 5.04 | 5.15 | 5.99 | 6.07 | 6.28 | 5.38 | 4.42 | 5.34 | 6.94 | 7.10 | 7.13 | 9.40 | 9.87 | 9.68 |
| Elongn | 52.00 | 50.33 | 46.00 | 19.86 | 21.06 | 21.07 | 214.33 | 209.33 | 190.00 | 53.23 | 68.20 | 64.30 | 51.23 | 58.30 | 59.07 |
| Duro | 85.00 | 85.00 | 85.00 | 90.00 | 90.00 | 90.00 | 80.00 | 80.00 | 80.00 | 85.00 | 85.00 | 85.00 | 90.00 | 90.00 | 90.00 |
| IZOD ft-lb/in | 4.38 | 4.55 | 4.11 | 2.94 | 2.53 | 2.30 | 4.23 | 3.91 | 3.96 | 4.22 | 4.12 | 4.14 | 3.09 | 5.36 | 3.30 |
| MFI g/10 min | 0.27 | 0.22 | 0.25 | 1.40 | 0.70 | 0.58 | 13.53 | 17.88 | 21.65 | 9.25 | 6.92 | 5.71 | 23.64 | 22.26 | 21.46 |
| 230 C. 5 kg wt | | | | | | | | | | | | | | | |
| FlexMODMpa | 316.00 | 314.67 | 35.00 | 482.67 | 507.67 | 501.33 | 71.67 | 68.43 | 72.07 | 351.33 | 351.67 | 763.33 | 314.67 | 348.33 | 345.33 |
| Ave Screw Effects | 1 | 2 | 3 | 1 | 2 | 3 | 1 | 2 | 3 | 1 | 2 | 3 | 1 | 2 | 3 |
| Tensile Mpa | 5.08 | 5.07 | 5.12 | 6.10 | 6.10 | 6.14 | 5.43 | 4.28 | 5.42 | 7.36 | 6.68 | 7.36 | 12.00 | 8.00 | 8.96 |
| Elongn | 14.67 | 65.67 | 68.00 | 18.32 | 21.33 | 22.33 | 213.00 | 193.33 | 207.33 | 48.00 | 58.33 | 48.00 | 46.67 | 65.60 | 56.33 |
| Duro | 85.00 | 85.00 | 85.00 | 90.00 | 90.00 | 90.00 | 80.00 | 80.00 | 80.00 | 85.00 | 85.00 | 85.00 | 90.00 | 90.00 | 90.00 |
| IZOD ft-lb/in | 3.85 | 4.59 | 4.60 | 2.36 | 2.80 | 2.60 | 3.59 | 4.47 | 4.04 | 4.22 | 4.49 | 4.22 | 2.87 | 5.23 | 3.65 |
| MFI g/10 min | 0.43 | 0.16 | 0.15 | 1.53 | 0.74 | 0.40 | 18.03 | 17.28 | 17.75 | 5.74 | 8.19 | 5.74 | 26.53 | 16.03 | 24.80 |
| 230 C. 5 kg wt | | | | | | | | | | | | | | | |
| FlexMODMpa | 413.50 | 275.67 | 324.00 | 445.67 | 555.33 | 490.637 | 84.50 | 67.00 | 60.67 | 241.67 | 156.33 | 241.67 | 442.33 | 258.67 | 307.33 |

Table 3 illustrates combined results of screw geometry versus mixing temperatures for TPEs manufactured consistent with the methods of the described invention, and consisting of 70% elastomeric content and chemically compatible thermoplastic constituents. The illustrated blends include styrenic-based passenger tire crumb rubber DRP with polystyrene plastic, an Acrylonitrile elastomer DRP with ABS plastic and EPDM elastomer DRP with three polyolefin plastics. Table 3 is intended to be illustrated and not limiting.

In each the elastomeric phase was introduced to the extruder and subjected to shear kneading before mingling with the thermoplastic element of the compound. Increased shear by altering the screw geometry as well as selection of a mixing temperature just above the melt temperature of that particular thermoplastic yielded the most desired physical properties. Higher tensile strength, greater elongation and impact resistance as well as higher melt flow and lower flexural modulus were achieved under optimal processing conditions, whereby the highest degree of mixing homogeneity was achieved when the elastomer phase viscosity was reduced, and thermoplastic phase viscosity maintained at its highest level just above its melting point. The ability to manipulate the elastomer phase rheology is due to the utilization of pre de-vulcanized material prior to mixing as it is in a super viscous liquid state.

Experiments were also performed to compare the methods of the prior art with methods in accordance with embodiments of the invention. The results are shown in the following table.

TABLE 4
Comparison Sample of De-vulc EPDM from DRP vs
methods described in U.S. Pat. No. 6,313,183

| | | | | | Melt |
|---|---|---|---|---|---|
| | | | | | Flow |
| | | Tensile | Tensile | Notched | MFI |
| | Resin | Strength | Modulus | Izod | (gm/10 |
| Formulation | % | (MPa) | (MPa) | (J/m) | min) |
| A | | | | | |
| 50% PP with EPDM | | | | | |
| DRP (NRT- | | | | | |
| applicant-Method) | | | | | |
| 85050 PP VIR60 | 50 | 11 ± 0.3 | 221 ± 18 | 552 | 5.16 |
| B | | | | | |
| 50% PP with EPDM | | | | | |
| (Devulcanized in | | | | | |
| situ Method as | | | | | |
| per prior art) | | | | | |
| 85050 PP VIR60 | 50 | 11 +/_ 0.2 | 240 +/_ 11 | 526 | Fractional* |

Note:
*Insufficient met flow to injection mold

Using the same formulation and starting resin, comparable samples were produced. Sample A (applicant method) used pre-devulcanized EPDM and subsequent staged blending using the method in accordance with embodiments of the invention. Sample B was obtained using the method described in U.S. Pat. No. 6,313,183, whereby the material was not pre-de-vulcanized prior to blending.

With the methods in accordance the invention the most notable differences are primarily in melt flow and secondarily in impact strength (as measured by the IZOD). The improved melt flow is of significant benefit for the processability of the material (e.g. injection molding) and is due to the sequence of the invention steps that lead to the greater degree of de-vulcanization of the EPDM in sample A prior to its blending with a plastic compound, and as such, the greater homogenization of the typically disparate materials. This liquid phase mixing also explains the difference in IZOD given the improved homogeneity of the resin and de-vulcanized rubber that can be achieved by blending in a fully liquid phase.

A slight improvement in impact strength may also be attributed to greater homogeneity of the mixture but the differences are not great enough to establish that fact on one experimental sample. Embodiments of the invention offer the advantage over the prior art in retaining a melt flow, which is suitable to effectively process the material into useable goods.

Of note also is the improvement in brittleness properties of the plastic, which correspond to the impact characteristics as represented by the IZOD numbers, which increase with the efficacy of the elastomeric content. The efficacy of the elastomeric content is dependent on its optimal de-vulcanization prior to its subsequent liquid state blending with plastic. IZOD impact testing is an ASTM standard method of determining the impact resistance of materials. Another advantage of the methods in accordance with the invention is that it is possible to employ a continuous mixing process apparatus like a twin-screw extruder of Farrel Continuous Mixer (FCM) for mixing. DRP from pre-de-vulcanization of the cured elastomer material is a free flowing powder. This presents processing advantages over virgin rubber or sheeted rubber scrap in that it is addable to twin screw mixing processes through continuous loss-in-weight feeder systems. Such systems are more commonly employed in thermoplastic compounding practice than bulk batch mixing (Banbury) employed in rubber compounding, although any suitable high shear mixer can be used.

Considering embodiments of the invention using DRP, a super viscous liquid, application of shear will bring about a reduction in viscosity. The applicant generally found maximum physical property results were achieved at the highest shear configuration. With respect to temperature best results were mostly achieved at the lower temperature of the examined temperature range. With respect to thermoplastics the highest viscosity is achieved immediately upon softening.

Therefore, the pre-devulcanization and transmutation of the elastomer to a super viscous liquid with subsequent shearing to further reduce viscosity is a core teaching of embodiments of the invention to achieving maximum physical property results. Coupled with this condition, the maintenance of temperature ideally within 5 deg Celcius of the melt point of the thermoplastic and as such whereby the thermoplastic phase is maintained at its highest viscosity, also translates into improved physical properties. Improved physical properties for mixtures occur when the most complete homogenous phase of the constituents is acquired by virtue of the minimization of the viscosity-differential between the elastomeric and thermoplastic constituents.

Below are some examples of specific method steps tested by the present applicant. Such examples are meant to be illustrative rather than limiting.

### Example 1

### 17030HIPS

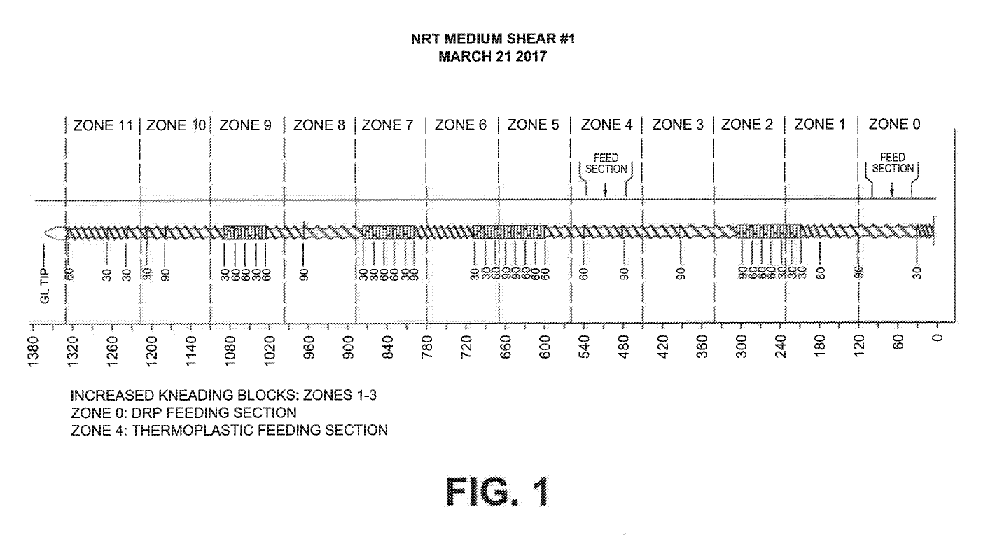

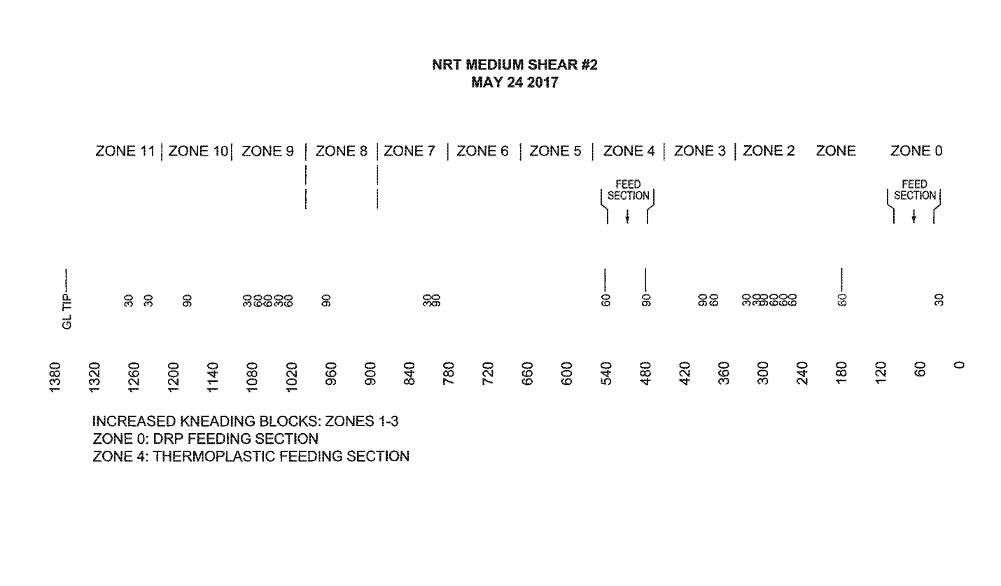

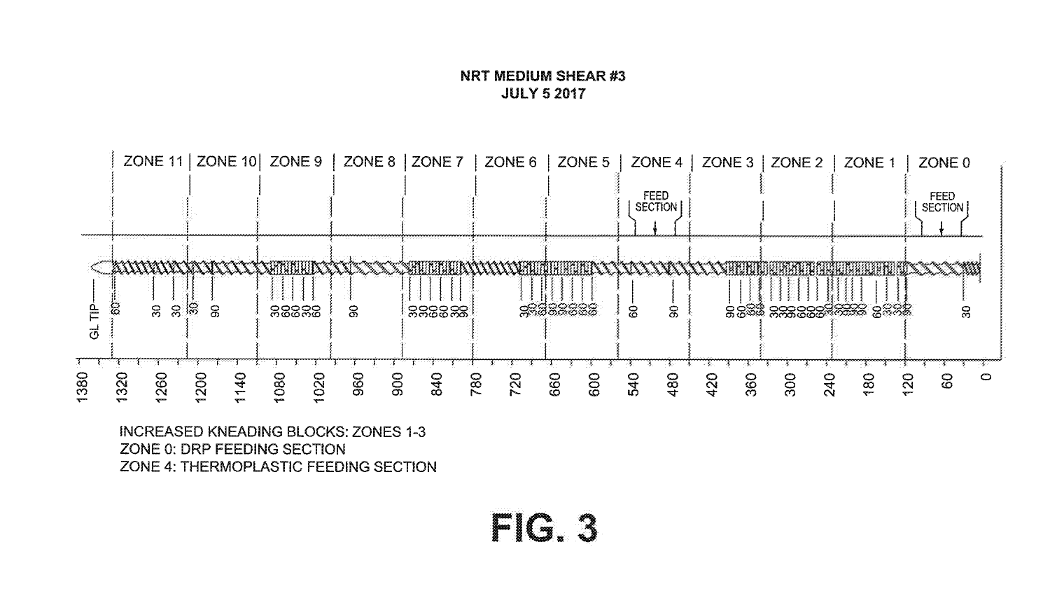

SBR DRP was introduced to a 27.5 mm Leistritz twin screw extruder at a rate of 7 Kg per hour. The apparatus was configured with screw geometry as displayed in FIG. 1-3. For each of three trials. The extruder temperature zones were set to to 150, 160, and 170 Celsius for each of three trials. The extrusion rate was 125 RPM for all successive trials. A total of nine trials were performed.

High Impact Polystyrene regrind was introduced at Zone 4 of the extruder as in FIG. 1-3 at a rate of 3 Kg/hr. Material was pelletized and injection molded at 200 C for testing purposes. Test results are displayed in Table 3: Optimal mixing conditions determined by maximal physical properties were achieved with the 3^{rd} most aggressive screw configuration and the lowest temperature selected.

### Example 2

### 47030ABS

NBR DRP was introduced to a 27.5 mm Leistritz twin screw extruder at a rate on 7 Kg per hour. The apparatus was configured with screw geometry as displayed in FIG. 1-3. For each of three trials. The extruder temperature zones were set to 175, 200, and 225 Celsius for each of three trials. The extrusion rate was 125 RPM for all successive trials. A total of nine trials were performed.

Acrylonitrile Butadiene Styrene thermoplastic was introduced at Zone 4 of the extruder as in FIG. 1-3 at a rate of 3 Kg/hr. Material was pelletized and injection molded at 200 C for testing purposes. Test results are displayed in Table 3:

Optimal mixing conditions determined by maximal physical properties were achieved with the 3rd most aggressive screw configuration and the lowest temperature selected.

### Example 3

### 87030 LLDPE

EPDM DRP was introduced to a 27.5 mm Leistritz twin screw extruder at a rate on 7 Kg per hour. The apparatus was configured with screw geometry as displayed in FIG. 1-3. For each of three trials. The extruder temperature zones were set to 175, 185, and 200 Celsius for each of three trials. The extrusion rate was 125 RPM for all successive trials. A total of nine trials were performed.

Low Linear Density Polyethylene regrind thermoplastic was introduced at Zone 4 of the extruder as in FIG. 1-3 at a rate of 3 Kg/hr. Material was pelletized and injection molded at 200 C for testing purposes. Test results are displayed in Table 3: Optimal mixing conditions determined by maximal physical properties were achieved with the 3rd most aggressive screw configuration and the lowest temperature selected.

### Example 4

### 87030 HDPE

EPDM DRP was introduced to a 27.5 mm Leistritz twin screw extruder at a rate on 7 Kg per hour. The apparatus was configured with screw geometry as displayed in FIG. 1-3. For each of three trials. The extruder temperature zones were set to 175, 185, and 200 Celsius for each of three trials. The extrusion rate was 125 RPM for all successive trials. A total of nine trials were performed.

High Density Polyethylene regrind thermoplastic was introduced at Zone 4 of the extruder as in FIG. 1-3 at a rate of 3 Kg/hr. Material was pelletized and injection molded at 200 C for testing purposes. Test results are displayed in Table 3: Optimal mixing conditions determined by maximal physical properties were achieved with the 3rd most aggressive screw configuration and the lowest temperature selected.

### Example 5

### 87030 PP

EPDM DRP was introduced to a 27.5 mm Leistritz twin screw extruder at a rate on 7 Kg per hour. The apparatus was configured with screw geometry as displayed in FIG. 1-3. For each of three trials. The extruder temperature zones were set to 170, 185, and 200 Celsius for each of three trials. The extrusion rate was 125 RPM for all successive trials. A total of nine trials were performed.

Polypropylene homopolymer thermoplastic was introduced at Zone 4 of the extruder as in FIG. 1-3 at a rate of 3 Kg/hr. Material was pelletized and injection molded at 200 C for testing purposes. Test results are displayed in Table 3: Optimal mixing conditions determined by maximal physical properties were achieved with the 3rd most aggressive screw configuration and the medium temperature selected. It was later determined 170 C was insufficient to melt the polypropylene homopolymer, thus 185 C was the lowest temperature setting employed above the melt temperature of the thermoplastics.

The progressive increase in the average for the acquired physical properties, as shown in Table 3, with the addition of shear inducing elements to the screw geometry and regression of physical properties with increasing process temperatures indicate:
1. Additional shear decreases the viscosity of the elastomer phase
2. Increasing temperature of the process lowers the viscosity of the thermoplastic phase
3. Separation of the input of materials allows the conditioning of the elastomer phase prior to comingling with the thermoplastic phase.
4. Best physical properties attained whereby constituent viscosities are closest in value.
5. Pre-de-vulcanization of the elastomer phase allows for the greatest viscosity reduction prior to comingling with the thermoplastic phase due to its change of physical state from solid to super viscous liquid.

Numerous modifications may be made without departing from the spirit and scope of the invention as defined in the appended claims.

We claim:

1. A method of making a thermoplastic elastomer, comprising: utilizing a de-vulcanized elastomeric material which as such is a liquid phase component; subsequently mixing said liquid phase component with a compatible thermoplastic polymer at a temperature above the melting point thereof; and cooling the resulting mixture to produce a solid thermoplastic elastomer.

2. A method as claimed in claim 1, comprising mixing about 25-75% de-vulcanized elastomeric polymer with about 25-75% post-consumer, post-industrial or virgin thermoplastic resin with appropriate monomeric content.

3. A method as claimed in claim 1 comprising mixing about 30-70% de-vulcanized SBR/NR derived from post-consumer tire crumb with about 30-70% virgin, post-industrial or post-consumer polystyrene resins.

4. A method as claimed in claim 1 comprising mixing about 30-70% de-vulcanized SBR/NR derived from post-consumer tire crumb with about 30-70% virgin, post-industrial or post-consumer polyolefin resins.

5. A method as claimed in claim 1 comprising mixing about 30-70% de-vulcanized NBR with about 30-70% virgin, post-industrial or post-consumer ABS polymer.

6. A method as claimed in claim 1 comprising mixing about 30-70% de-vulcanized EPDM with about 30-70% virgin, post-industrial and post-consumer polyolefin resins.

7. A method as claimed in claim 1 comprising mixing about 30-70% de-vulcanized EPDM with about 30-70% virgin, post-industrial and post-consumer ethylene vinyl acetate polymer.

8. A method as claimed in claim 1 comprising mixing about 30-70% de-vulcanized post-consumer tire derived elastomer with about 30-70% virgin, post-industrial and post-consumer polyolefin resin.

9. A method as claimed in claim 1 wherein the mixing takes place in an internal mixer such as a Banbury mixer, twin-screw extruder or Farrel Continuous Mixer.

10. A method as claimed in claim 1 wherein the thermoplastic polymer elements may vary from 10-90% of the mixture.

11. A method as claimed in claim 1 wherein the de-vulcanized elastomeric polymer elements may vary from 10-90% of the mixture.

12. A method as claimed in claim 1 wherein an additional thermoplastic polymer element may be added to produce a ter-polymer alloy.

13. A method of making a thermoplastic elastomer, comprising: utilizing a de-vulcanized elastomeric material which as such is a liquid phase component; subsequently mixing said liquid phase component with a compatible thermoplastic polymer at a temperature ideally within about 5 deg C above the melting point thereof; and cooling the resulting mixture to produce a solid thermoplastic elastomer.

14. The method of claim 13, wherein the thermoplastic is a monomer, copolymer or terpolymer.

15. The method of claim 13, wherein shear mixing is used to reduce the viscosity of the elastomer.

16. A method of making a thermoplastic elastomer using a mixer, comprising: introducing a de-vulcanized elastomer phase to the mixer, reducing the elastomer phase viscosity by applied shear using the mixer, subsequently introducing a thermoplastic phase at a process temperature minimally above the melt point of the utilized plastic; and subsequently mixing the thermoplastic phase and elastomer phase to produce a thermoplastic elastomer.

17. The method of claim 16, wherein the temperature is ideally within about 5 deg Celsius above of the melt point of the thermoplastic.
